(19) United States
(12) Patent Application Publication
(10) Pub. No.: US 2026/0249896 A1
(43) Pub. Date: Aug. 27, 2026

(54) Method for Operating a Steering System, and Steering System

(71) Applicant: Bayerische Motoren Werke Aktiengesellschaft, Muenchen (DE)

(72) Inventors: Bernhard SCHMIDT, Muenchen (DE); Matthias SCHOELZEL, Muenchen (DE)

(21) Appl. No.: 19/161,538

(22) PCT Filed: Feb. 5, 2024
(86) PCT No.: PCT/DE2024/100091

§ 371 Date: Sep. 2, 2025

(30) Foreign Application Priority Data
Mar. 3, 2023 (DE) 10 2023 105 329.9

(51) Int. Cl. B62D 1/183; B60W 10/20; B60W 60/00

(52) U.S. Cl. CPC B62D 1/183; B60W 10/20; B60W 60/0051; B60W 60/0061; B60W 2540/215; B60W 2710/20

(57) ABSTRACT

The present disclosure relates to a method for operating a steering system for a vehicle, where the vehicle is capable of operating in a manual driving mode and an autonomous driving mode. In a manual driving mode, the steering handle is in an actuatable state in order to manually actuate a steering movement. In an autonomous driving mode, the steering handle is in a locked, non-actuatable state. The vehicle driver initiates a transfer from the manual driving mode to the autonomous driving mode during a drive of the vehicle. At least one plausibility check is carried out during the transition from the actuatable state to the locked state of the steering handle, and when the plausibility check results in that the initiation is not desired by the vehicle driver, the transition from the actuated state to the locked state of the steering handle is canceled.

### BACKGROUND AND SUMMARY

The present disclosure relates to a method for operating a steering system that can be operated in a manual driving mode as well as in an autonomous driving mode, and to a steering system for carrying out the method. Reference is made by way of example to DE 102 59 684A1, 1 916 652, DE 10 2016 210 622A1, DE 10 2016 011 461 A1 and US 2018 008 6297 A1 as prior art.

It is well known that nowadays conventional motor vehicles, in particular passenger vehicles, have a substantially stationary steering column on which a steering wheel is arranged. Particularly in the field of steering wheels, in addition to this conventional design of steering column and steering wheel, other configurations of motor vehicle steering handles are conceivable and possible, and these are distinguished, for example, by increased convenience due to wider ranging options for relocation. DE 102 59 684 A1 thus discloses, for example, a steering wheel handle for a motor vehicle that is arranged on an arm that can be pivoted about an axis running essentially in the longitudinal direction of the vehicle and that can be relocated using same.

The aforementioned German document 1 916 652 also discloses a steering wheel, this document demonstrating a steering wheel that can be folded away, for example in the direction of the floor of the vehicle, so as to increase convenience, more specifically for the vehicle occupant to better exit the vehicle.

However, in the age of driver assistance systems and autonomous driving, demands on convenience, in particular, are continuously increasing. It is thus desirable, for example for reasons of convenience and space, for the steering wheel to no longer be positioned in direct reach of the driver in the event of autonomous vehicle guidance. Nevertheless, the driver must be able at any time to be able to intervene in the (autonomous) driving situation. Such restrictions and transfer conditions for moving from manual driving to autonomous driving describe a technical challenge in the development and design of vehicles and vehicle systems.

DE 10 2016 210 622 A1 discloses, for example, a method for transferring the vehicle guidance of a motor vehicle from a first vehicle guidance system to another vehicle guidance system. The transition of a vehicle guidance device, which vehicle guidance device also comprises a steering wheel, changes the vehicle guidance from a first vehicle guidance system to a second vehicle guidance system. In this case, the vehicle guidance device is brought from a first installation position into at least one second installation position in the vehicle by way of a translatory movement upon actuation of an actuation apparatus.

Steering systems, as shown, for example, in US 2018 008 6297A1, which are shifted backward in the direction of the front of the vehicle in autonomous travel and are shifted outward again (for example the direction of the dashboard) in manual travel. US 2018 008 6297 A1 in this case shows a steering wheel that can be moved into the dashboard and that comprises a display in the steering wheel hub. An airbag module is arranged behind the display.

DE 10 2016 011 461 A1 discloses a vehicle that can be operated in an autonomous driving mode and in a manual driving mode. The steering handle can be collapsed for operating the vehicle in an autonomous driving mode and a display, also arranged in front of a vehicle driver, can be moved away from the driver in the direction of the front of a vehicle. The driver can thus use the display for entertainment during autonomous travel of the vehicle, while the display is pivoted back in the direction of the front of a vehicle and the steering wheel is at least partly extended again in manual travel of the vehicle.

Numerous embodiments in which a steering handle is folded in or moved such that the interior of the vehicle can be better used by the vehicle occupants during autonomous travel are known. In the case of fully autonomous driving of the vehicle, a transition from a manual driving mode to an autonomous driving mode of the vehicle should also be possible during travel of the vehicle. However, there is then the risk that unintended movement and folding of the steering handle takes place during travel due to, for example, a technical fault or incorrect operator control by the driver.

It is therefore the object of the invention to provide a method for operating a steering system that prevents an unintended transition from a manual actuated steering handle in an autonomous steering mode.

### BRIEF DESCRIPTION OF THE DRAWINGS

FIG. 1 illustrates one form of a method for operating a steering system that can be operated in a manual driving mode as well as in an autonomous driving mode.

FIG. 2 illustrates one form of a steering system that can be operated in a manual driving mode as well as in an autonomous driving mode.

### DETAILED DESCRIPTION OF THE DRAWINGS

The above-described object is achieved by way of a method and by way of a steering handle having the features of the independent claims. The dependent claims contain advantageous designs and developments.

The present disclosure proposes a method for operating a steering system of a vehicle, wherein the vehicle can be operated in a manual driving mode as well as in an autonomous driving mode.

In an autonomous driving mode, the vehicle or the vehicle control system or a driver assistance system takes over the vehicle guidance. A vehicle driver must then no longer take over a vehicle guidance task themselves. In a partly autonomous or highly automated driving mode, individual vehicle guidance tasks, for example the transverse vehicle guidance (that is to say the steering), are taken over by suitable driver assistance systems.

If required, for example in critical situations or even if the driver themselves wishes, the driver or a vehicle occupant must or can at least partly take over the vehicle guidance of the vehicle themselves. The driving mode changes from the autonomous driving mode to the manual driving mode.

In manual driving mode, the vehicle driver at least partly takes over the vehicle guidance. In this case, the vehicle driver must then take over the transverse guidance of the vehicle. They must therefore steer the vehicle themselves via a steering handle.

Provision is made here for the steering handle to be in an actuatable state in a manual driving mode of the vehicle.

In the context of the present disclosure, an actuatable state means that the steering handle is designed and positioned in the interior of the vehicle in such a way that a vehicle driver is able to operate the steering handle without any problems.

In contrast, in an autonomous driving mode of the vehicle, the steering handle is in a non-actuatable, locked state.

In the context of the present disclosure, a locked state means that the steering handle is positioned in the vehicle or designed in such a way that it is not reached by a vehicle driver or that it cannot be actuated by a vehicle occupant or actuation has no influence on the driving function.

In this case, the steering handle can be retracted or folded into a dashboard of the vehicle, in particular in the direction of the front of the vehicle. In addition or as an alternative, the steering handle may be folded into itself. In addition or as an alternative, it is also possible that the steering handle is mechanically locked in such a way that actuation is no longer possible.

Provision is also made for a transition from the manual driving mode to the autonomous driving mode to be initiated during travel of the vehicle in principle by a vehicle driver or a driver or an occupant, or a sufficient indication for an automatic takeover is identified. For example, such an initiation is performed by way of a corresponding button or a corresponding switch in the vehicle and/or by way of a corresponding gesture or movement of the vehicle occupant.

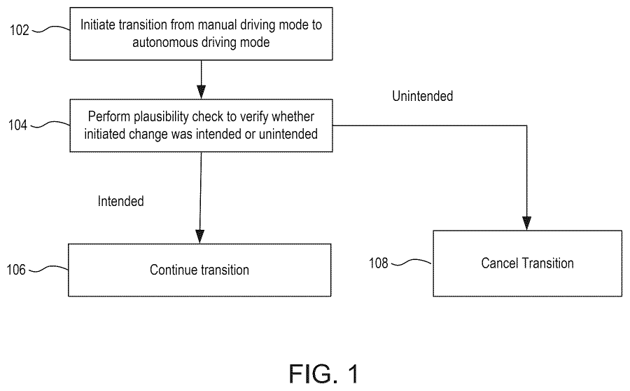

FIG. 1 illustrates one form of a method for operating a steering system that can be operated in a manual driving mode as well as in an autonomous driving mode. If a transition from the manual driving mode to the autonomous driving mode is initiated (step 102) during travel of the vehicle by a vehicle driver, the steering handle is brought from an actuatable state to a locked state.

Provision is also made here for a plausibility check to be carried out when or while the steering handle is brought from an actuatable state to a locked state (that is to say upon transition to the locked state). The plausibility check (step 104) verifies whether the initiation of the change from an actuatable state to a locked state of the driving handle by the vehicle driver was intended or unintended. If the plausibility check reveals that the change was intended (=plausible), the transition to the locked state is continued (step 106).

If the plausibility check reveals that the transition was unintended, for example because there is a fault in the system or incorrect operator control took place, the transition to the locked state is canceled (step 108). The steering handle is then preferably brought back to its original, actuatable state. The driver is then preferably requested to operate the driving handle manually themselves again.

The plausibility check is carried out here preferably at a time at which the locked state of the steering handle has not yet been reached (even if restricted for the time being) and the vehicle driver does not have the option to operate the steering handle and to manually steer the vehicle.

The proposed plausibility check can therefore advantageously be used to prevent, in good time, a locked state of the handle that is undesired by the vehicle driver.

Available physical vehicle variables and/or a steering handle torque and/or a transverse acceleration of the vehicle and/or a longitudinal acceleration of the vehicle and/or a vehicle velocity and/or information relating to interior monitoring of the vehicle and/or a seat position of the vehicle driver are used in the plausibility check.

It is thus verified, for example by means of seat occupancy sensors or an interior camera, whether a vehicle driver has already sat on a different seat to the driver's seat or whether they have already left the sitting position on the driver's seat. Leaving the driver's seat would indicate, for example, that the vehicle driver has requested an autonomous driving mode and the initiation of the locked mode appears plausible.

In one embodiment of the invention, the transition from the actuatable state to the locked state of the steering handle is divided into at least two phases, particularly preferably three phases. Provision is made here for a plausibility check to be carried out after each phase. In the context of this invention, “transition” means a spatial transformation of the steering handle from the actuatable state to the locked state. This transformation is, in particular, in the form of a movement or geometric change of the steering handle.

It becomes more difficult for a vehicle occupant to manually steer the vehicle with each advancing phase, that is to say the steering handle moves spatially closer to the locked state with each phase.

In the case of a steering handle that can be retracted in the direction of the front of the vehicle, a first phase represents a first retraction travel of the steering handle in the direction of the front of the vehicle. This first retraction travel is only a few centimeters, for example in order of magnitude of 1-3 cm. In this case, the steering handle is retracted slowly, for example over 2-5 seconds, in the direction of the front of the vehicle. A first plausibility check of the retraction movement of the steering handle is carried out after the first retraction travel has been reached.

If the check results in “plausible”, then the steering handle is retracted by a second retraction travel in the direction of the front of the vehicle in the second phase. If the second retraction travel is reached, the steering handle is located in its final position in translatory terms. The second retraction travel is, for example, a further 10-15 cm and lasts a further 3-6 seconds.

After the final position has been reached (or else on the way to the final position), another plausibility check of the transformation is carried out to enable the transition to the third transformation phase. Only in the case of another check with a result of “plausible” does the last, most critical transformation phase begin, specifically in this particular example the folding of the steering handle, that is to say the final mechanical locking of the steering handle.

The individual transformation phases must proceed in a defined order but may be condensed and/or also parallelized at any time.

The steering handle does not necessarily have to be retracted in the direction of the front of the vehicle here. Any kind of movement or geometric change of the steering handle up to a locked state is possible.

The phase-wise transformation with the subsequent plausibility checks can therefore be used to prevent unintended and erroneous movements of the steering handle.

In addition to the method, the invention also proposes a steering system of the vehicle for carrying out implementations of the described method.

In this case, a steer-by-wire steering system is proposed, in particular. So-called steer-by-wire steering systems are already known from the prior art in different ways. Such a steer-by-wire steering system differs from the conventional steering systems in that the wheels are steered in a manner entirely decoupled from the mechanical steering movement of the driver or no longer through purely electronic transmission. The conventional mechanical transmission apparatuses are omitted and instead the driver generates data through their steering movement on the so-called steering handle or on the steering wheel, this data being fed to an electronic control unit. This control module evaluates the data and converts it into corresponding steering commands. The steering drive is thus driven, which executes the desired steering movement.

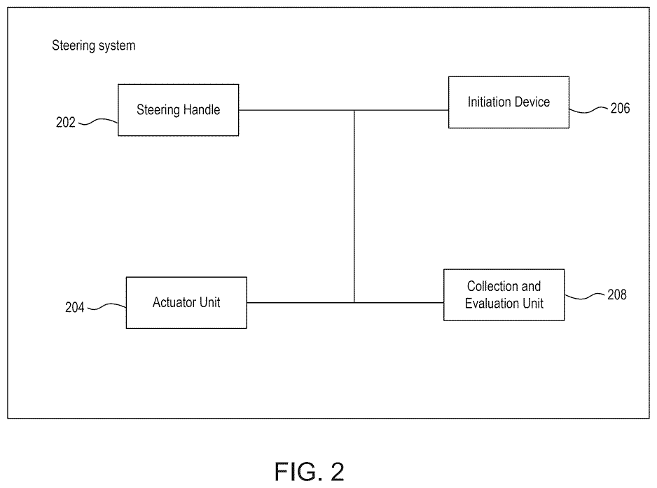

FIG. 2 illustrates one form of a steering system that can be operated in a manual driving mode as well as in an autonomous driving mode. The steering system also comprises the aforementioned steering handle 202 for manually actuating a steering movement in a manual driving mode of the vehicle. In a manual driving mode, the steering handle is in an above-described actuatable state, while it is in a locked state in an autonomous driving mode. In the locked state, it is no longer manually actuatable by the vehicle driver. The steering handle may be, for example, a steering wheel.

An actuator unit 204 is also provided, which adjusts or moves the steering handle from the actuatable state to the locked state. The actuator unit, that is to say a motor, for example, may be electrically and/or mechanically and/or magnetically actuatable.

An initiation device 206 for the vehicle driver to manually trigger the manual driving mode during travel of the vehicle is furthermore provided. As already mentioned further above, this may be a switch what a button in the vehicle interior. As an alternative or in addition, it is also possible that a gesture or corresponding movement of the vehicle driver constitutes such an initiation.

A collection and evaluation unit 108 is also required to be able to perform a plausibility check.

1-9. (canceled)

10. A method for operating a steering system of a vehicle, wherein the vehicle can be operated in a manual driving mode as well as in an autonomous driving mode, wherein, in a manual driving mode, a steering handle is in an actuatable state in order to manually actuate a steering movement, wherein, in an autonomous driving mode of the vehicle, the steering handle is in a non-actuatable, locked state, and wherein a vehicle driver initiates a transfer from the manual driving mode to the autonomous driving mode during travel of the vehicle, the method comprising:
carrying out at least one plausibility check upon the transition from the actuatable state to the locked state of the steering handle; and
when the plausibility check reveals that the initiation is not intended by the vehicle driver, cancelling the transition from the actuated state to the locked state of the steering handle.

11. The method according to claim 10, wherein the transition from the actuatable state to the locked state of the steering handle is divided into at least two phases, wherein a plausibility check is carried out after each phase.

12. The method according to claim 10, wherein:
the steering handle is at least one of extended or folded out in the direction of the vehicle interior in an actuatable state;
the steering handle is at least one of retracted or folded in upon initiation of the autonomous driving mode;
the steering handle is mechanically locked after being at least one of fully retracted or folded in such that it can no longer be actuated by the vehicle driver; and
at least one plausibility check is carried out before the steering handle is at least one of fully folded in or retracted or before the steering handle is locked.

13. The method according to claim 10, wherein, upon initiation of the autonomous driving mode, the steering handle is partly retracted and/or folded in up to a first retraction travel and/or fold-in travel in a first phase, wherein a first plausibility check is carried out after the first retraction travel and/or fold-in travel has been reached.

14. The method according to claim 13, wherein, when the first plausibility check was plausible, the steering handle is retracted and/or folded in up to a second retraction travel in a second phase and a second plausibility check is carried out when the second retraction travel and/or fold-in travel is reached.

15. The method according to claim 10, wherein a plausibility check is carried out immediately before the steering handle transitions to a locked state.

16. The method according to claim 10, wherein the plausibility check is based on at least one of available physical vehicle variables, a steering handle torque, a transverse acceleration of the vehicle, a longitudinal acceleration of the vehicle, a vehicle velocity, information relating to interior monitoring of the vehicle, or a seat position of the vehicle driver.

17. A steering system of a vehicle configured to carry out the method according to claim 10, wherein the vehicle can be operated in a manual driving mode as well as in an autonomous driving mode, steering system comprising:
a steering handle configured to manually actuating a steering movement in a manual driving mode of the vehicle, wherein the steering handle is in an actuatable state in a manual driving mode and the steering handle is in a locked state in an autonomous driving mode such that it can no longer be actuated by the vehicle driver;
an actuator unit configured to adjust the steering handle in an actuatable state and a locked state;
an initiation device configured for the vehicle driver to manually trigger the autonomous driving mode during travel of the vehicle; and
a collection and evaluation unit configured to collect and evaluate the data relating to the plausibility check.

18. The steering system according to claim 17, wherein the steering system is a steer-by-wire steering system.
